(19) United States
(12) Patent Application Publication
(10) Pub. No.: US 2026/0288423 A1
(43) Pub. Date: Sep. 24, 2026

(54) METHOD AND SYSTEM FOR CONVERTING USER INTERFACE (UI) DESIGN REPRESENTATION TO CODE

(71) Applicant: Verizon Patent and Licensing Inc., Basking Ridge, NJ (US)

(72) Inventors: Meenu Priya, Karnataka (IN); Mahock Abraham, Tamil Nadu (IN); Priya DR, Bangalore (IN); Madhavan Krishnan, Hyderabad (IN); Avanthi Katragadda, Tamil Nadu (IN); Vaishakh Vatavil, Kerala (IN); Vijayaraghavan Ramalingam, Tamil Nadu (IN)

(21) Appl. No.: 19/086,289

(22) Filed: Mar. 21, 2025

(51) Int. Cl. G06F 8/30

(52) U.S. Cl. CPC G06F 8/30

(57) ABSTRACT

One or more computing devices, systems, and/or methods for converting a UI design representation to code are provided. A design profile of the UI design representation may be determined. A code template catalog may be analyzed based upon the design profile to determine a set of matching code templates determined to match interface elements of the UI design representation. The set of matching code templates includes a first code template matching a first interface element and a second code template matching a second interface element. The code may be generated based upon the set of matching code templates and the design profile. The code includes a first set of code generated based upon the first code template and one or more first attributes indicated by the design profile and a second set of code generated based upon the second code template and one or more second attributes indicated by the design profile.

### BACKGROUND

Frontend code may define visual and/or interactive elements of a digital interface, influencing how users experience and/or engage with an application. The frontend code may translate design concepts into functional interfaces that may be optimized for responsiveness, accessibility, usability across different devices, performance, speed and/or efficiency.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A illustrates an example system for converting a user interface (UI) design representation to code, according to some embodiments.

FIG. 1B illustrates display of a UI design representation selection interface in an example system for converting a UI design representation to code, according to some embodiments.

FIG. 1C illustrates generation of a trained code generation model in an example system for converting a UI design representation to code, according to some embodiments.

FIG. 1D illustrates determination of a set of matching code templates in an example system for converting a UI design representation to code, according to some embodiments.

FIG. 1E illustrates generation of a set of code in an example system for converting a UI design representation to code, according to some embodiments.

FIG. 1F illustrates generation of a set of code in an example system for converting a UI design representation to code, according to some embodiments.

FIG. 1G illustrates generation of a set of code in an example system for converting a UI design representation to code, according to some embodiments.

FIG. 1H illustrates display of a code workspace interface in an example system for converting a UI design representation to code, according to some embodiments.

FIG. 1I illustrates display of a package settings interface in an example system for converting a UI design representation to code, according to some embodiments.

FIG. 1J illustrates display of a warning in an example system for converting a UI design representation to code, according to some embodiments.

FIG. 1K illustrates display of a selectable input for generating a set of code corresponding to a portion of interest of a UI design representation in an example system for converting a UI design representation to code, according to some embodiments.

FIG. 1L illustrates display of a code workspace interface in an example system for converting a UI design representation to code, according to some embodiments.

FIG. 1M illustrates display of a UI design representation screen selection interface in an example system for converting a UI design representation to code, according to some embodiments.

FIG. 1N illustrates a representation of hierarchical relationships between tags of a design profile in an example system for converting a UI design representation to code, according to some embodiments.

FIG. 1O illustrates a representation of hierarchical relationships between tags of a design profile in an example system for converting a UI design representation to code, according to some embodiments.

FIG. 2 is a flow chart illustrating an example method for converting a UI design representation to code, according to some embodiments.

FIG. 3 is a flow chart illustrating an example method, according to some embodiments.

FIG. 4 is a flow chart illustrating an example method for converting a UI design representation to code, according to some embodiments.

FIG. 5 is an illustration of a scenario featuring an example non-transitory machine-readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for converting a user interface (UI) design representation to code (e.g., frontend code) are provided. Users (e.g., developers, engineers, etc.) often face challenges when creating frontend code based upon UI design representations or incorporating updates from UI design representations into their frontend codebases. In the present disclosure, frontend code may refer to code that drives generation of a graphical user interface and/or defines how visual elements are rendered and/or arranged throughout the graphical user interface. For example, the frontend code may comprise one or more types of code (e.g., Hypertext Markup Language (HTML), Cascading Style Sheets (CSS), JavaScript, Typescript, etc.) for structuring content of the graphical user interface and/or defining styling and/or layout of the graphical user interface. Manually creating frontend code and/or translating design changes is time-consuming, and may be prone to errors when merely a subset of sections of the UI design representation are modified. A code generation tool is provided for automatically generating code for an entire UI design representation or for a subset of updated sections, which may greatly streamline the frontend update process, may significantly reduce development time and manual effort, and/or may ensure that an application frontend accurately reflects latest design iterations. The code generation tool may allow users to generate code for the entire screen, or to select the subset of (updated) sections within the UI design representation, which may minimize code changes, reducing errors and integration efforts. The code generation tool may provide a visual design representation that a user can preview, interact with, and/or make changes to. Hovering and/or clicking on specific elements may highlight the corresponding section for code generation (thereby simplifying the selection process such that users generate code for the intended elements, for example). Upon selecting a section, the code generation tool may generate code (e.g., frontend code) representing the design elements. Users may preview, copy, and/or download the generated code, facilitating easy integration into their existing codebase.

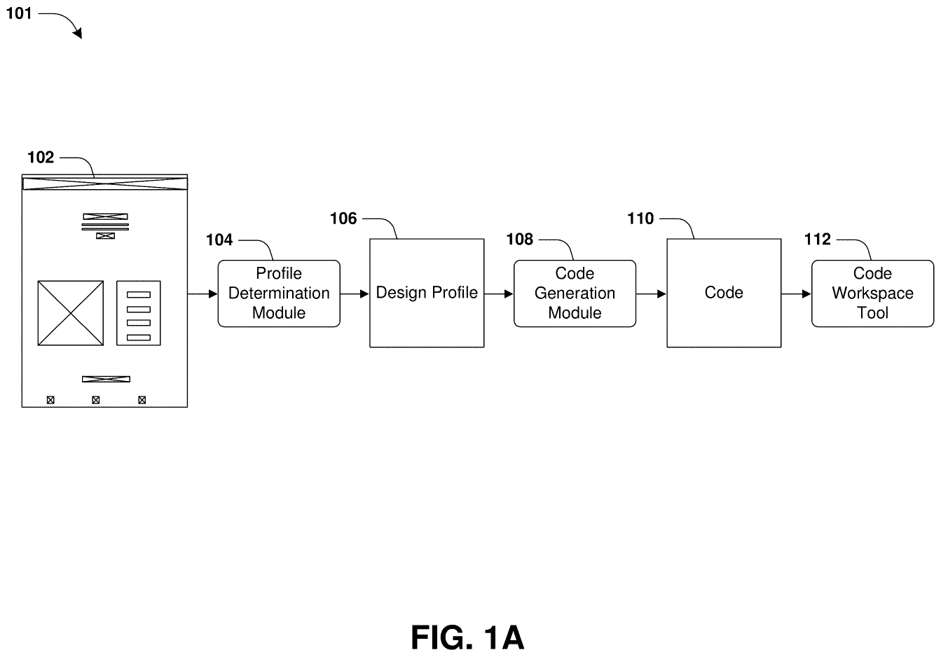

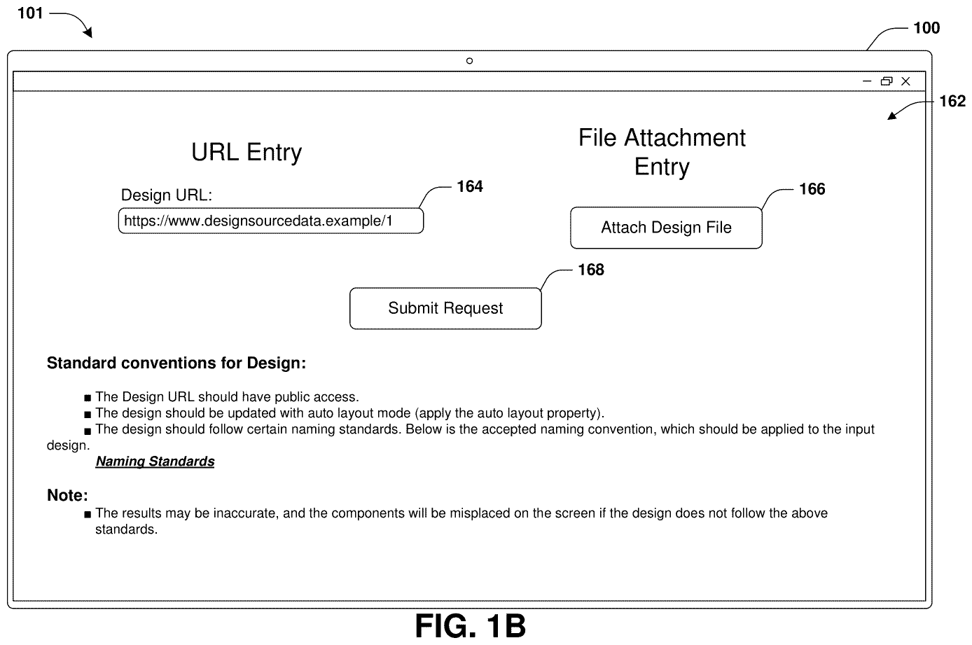

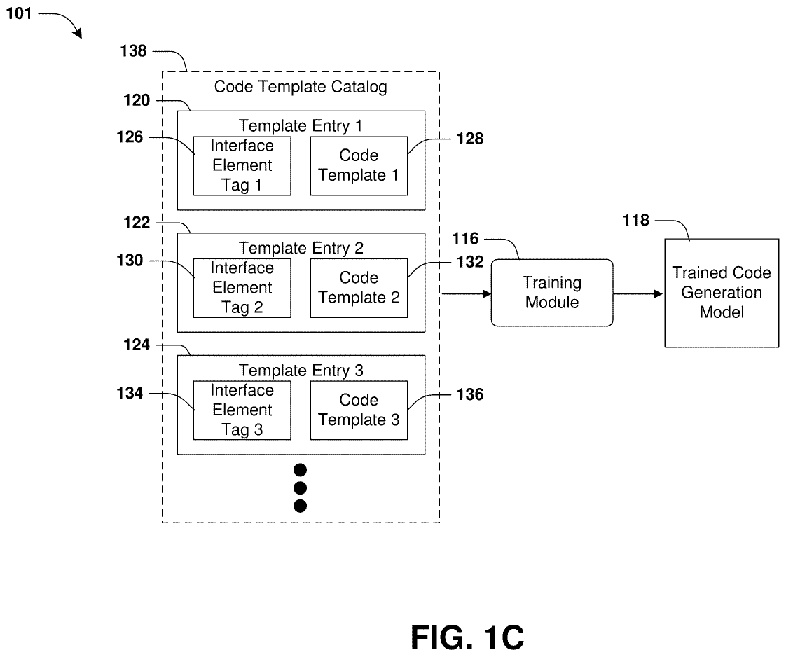

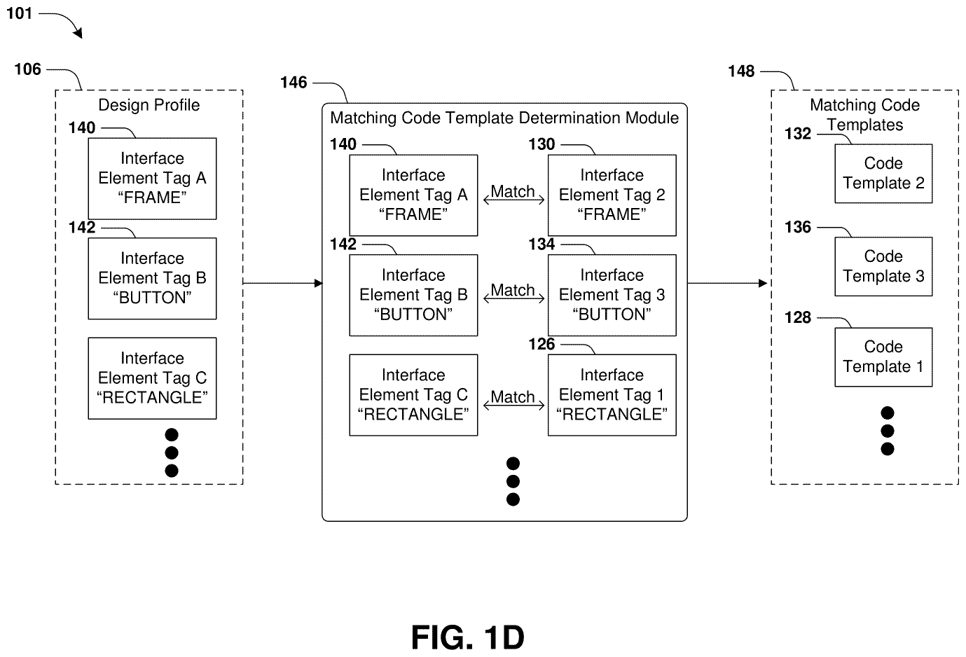

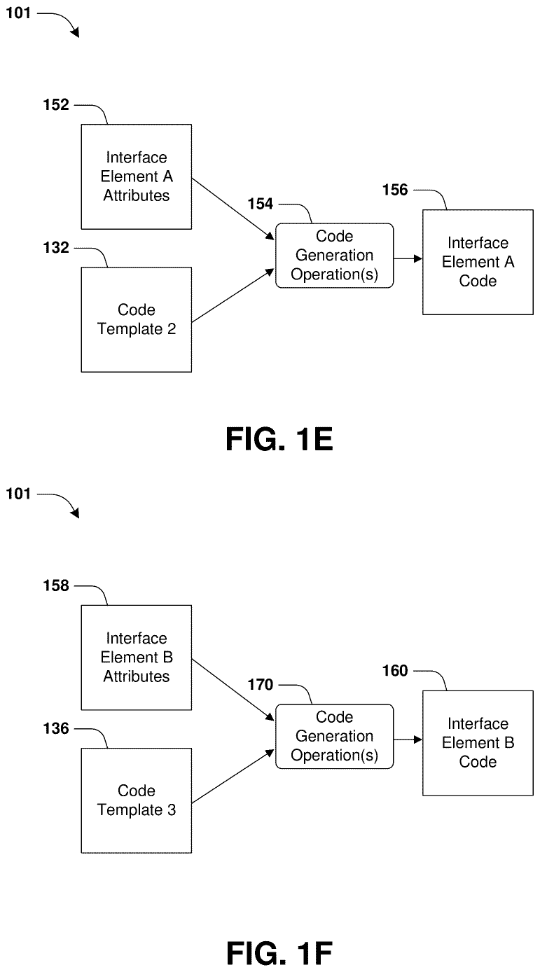

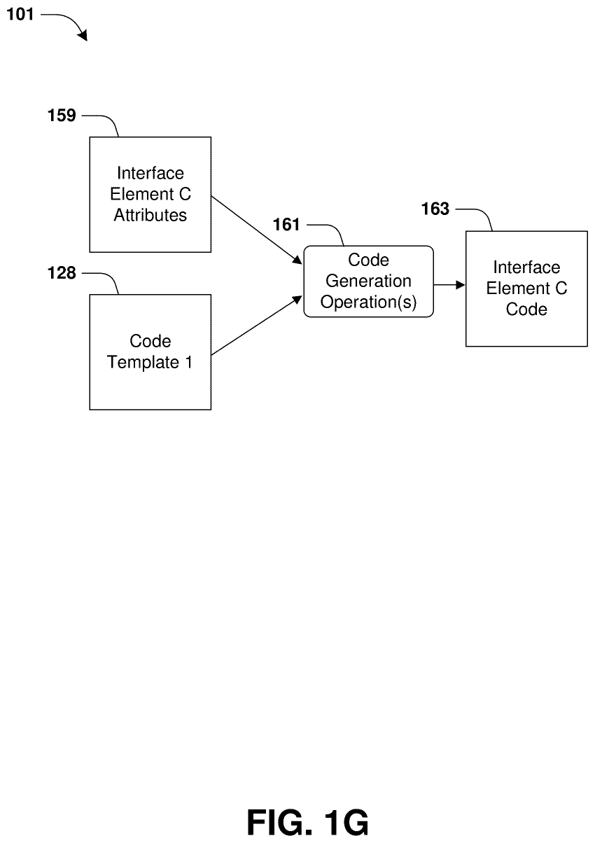

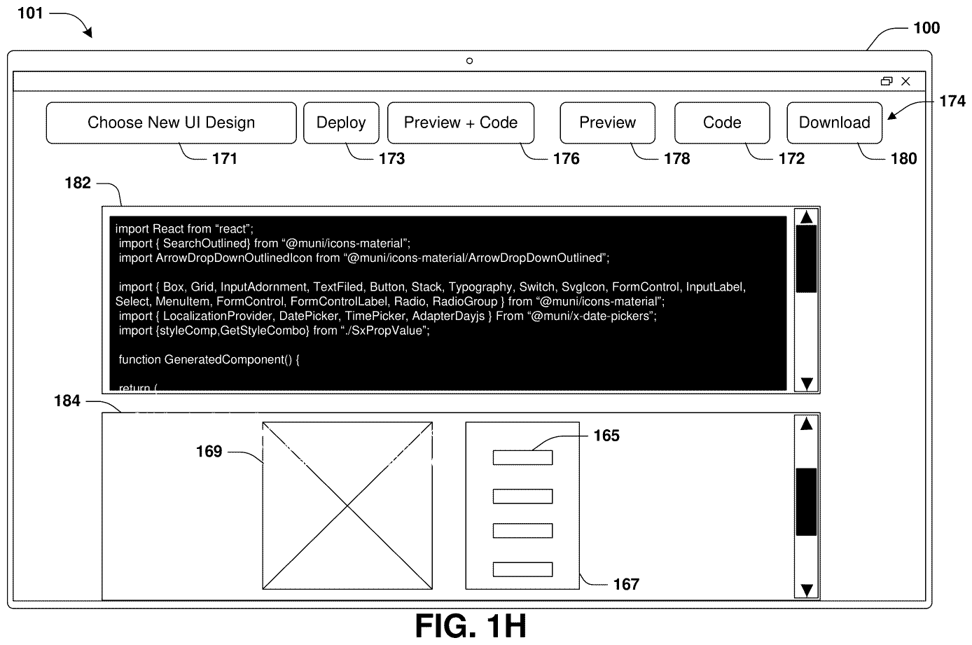

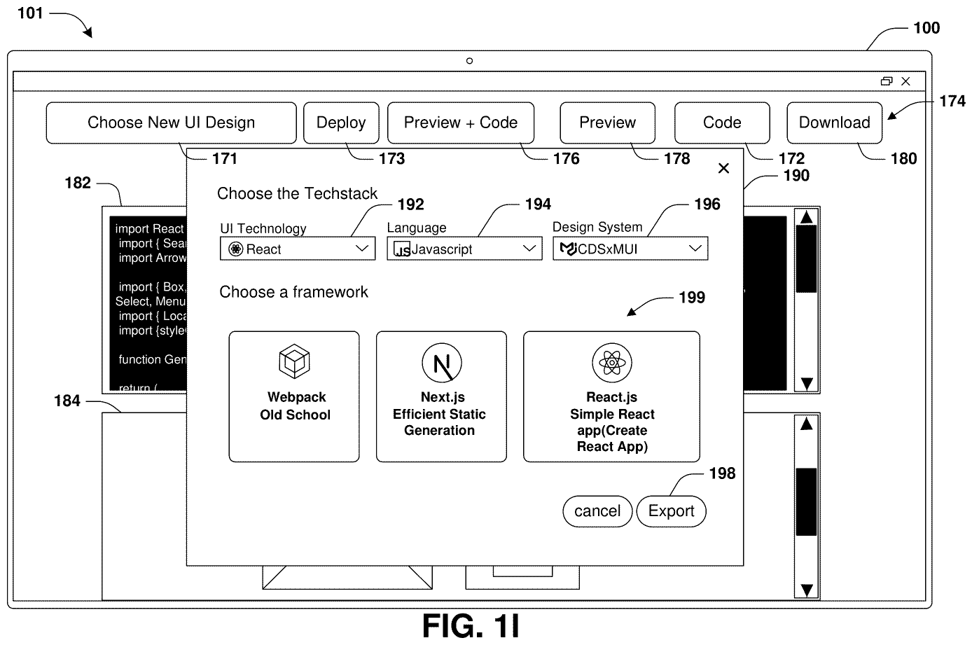

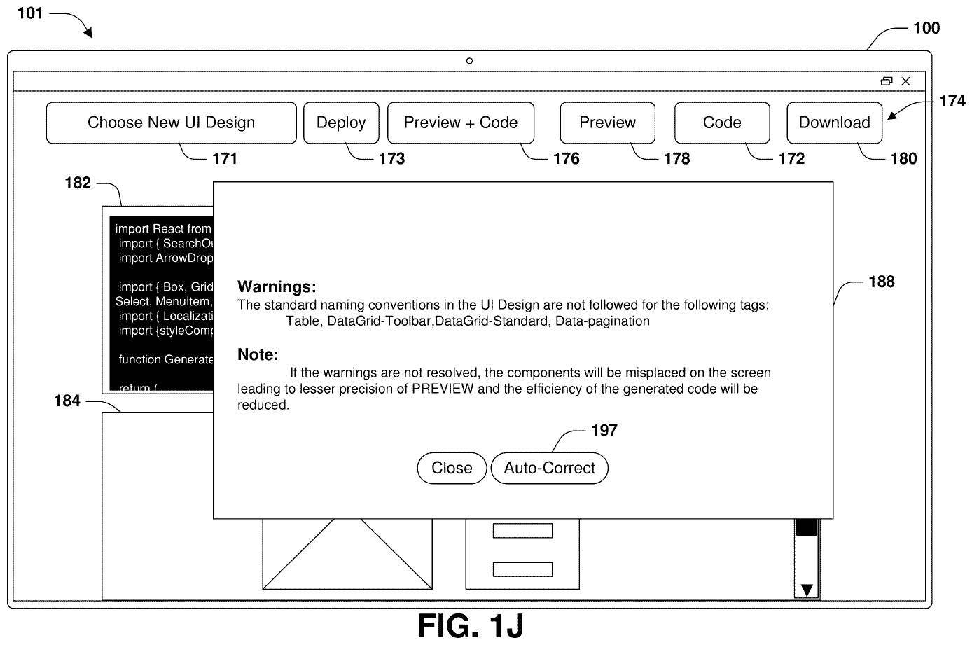

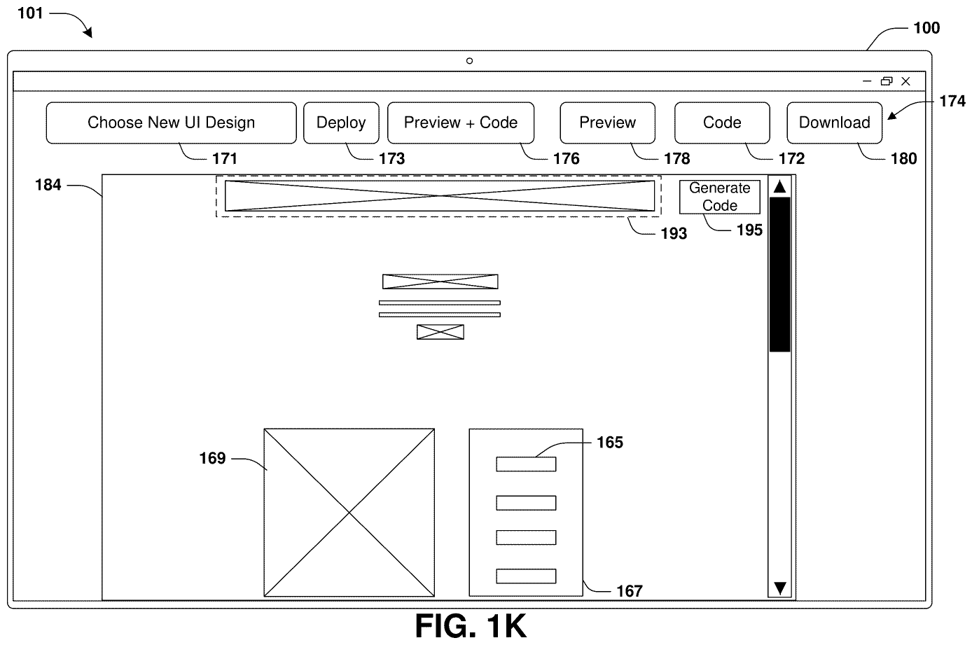

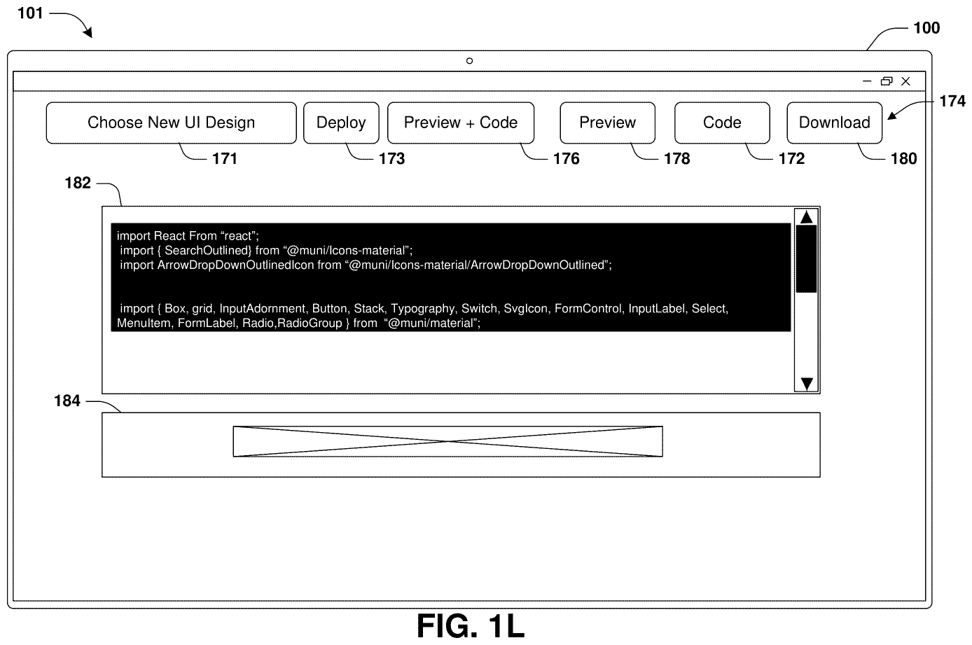

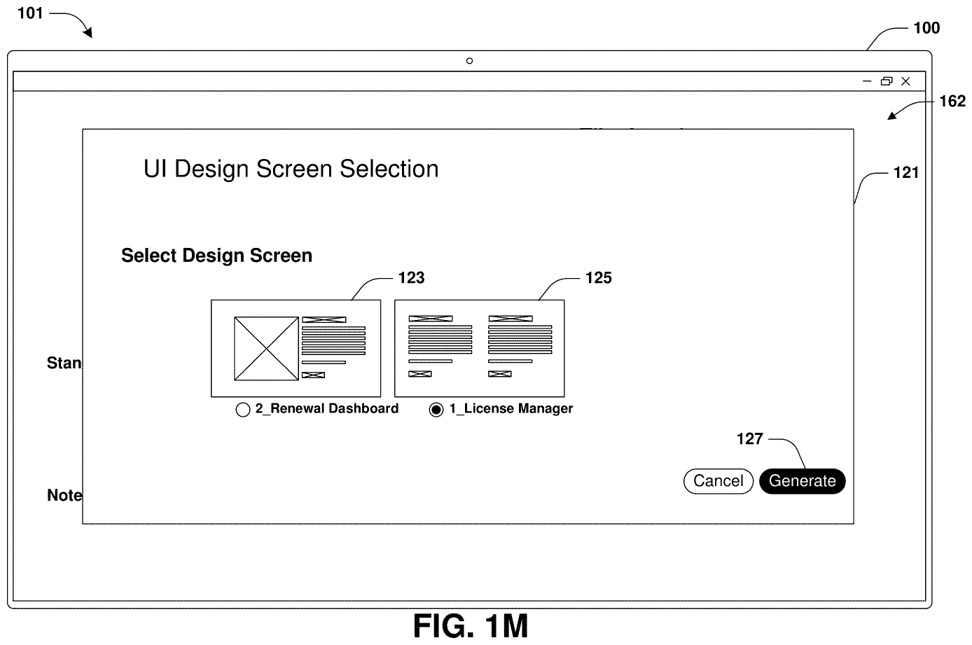

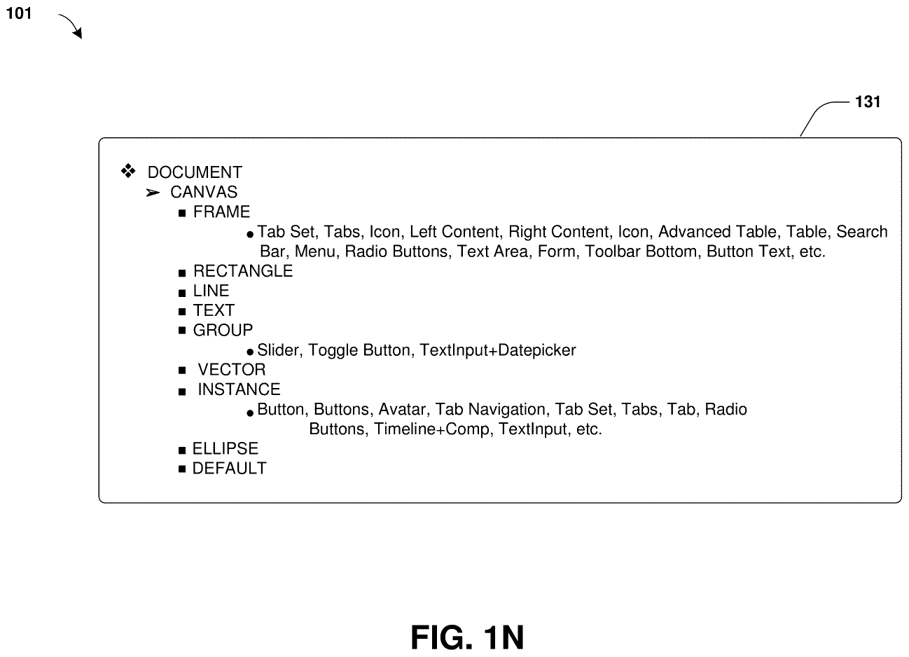

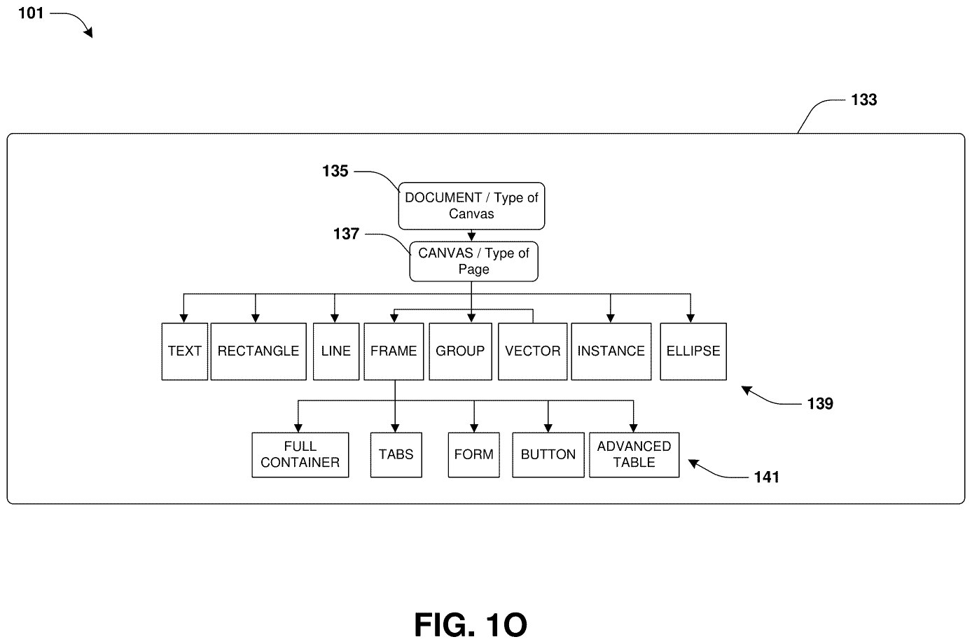

FIGS. 1A-1O illustrate examples of a system 101 for converting UI design representations to code. FIG. 1A illustrates generation of code 110 based upon a UI design representation 102. A code generation tool implemented by the system 101 may comprise a profile determination module 104 for determining a design profile 106 of the UI design representation 102. The code generation tool may comprise a code generation module 108 to generate code 110 based upon the design profile 106. The code generation tool may comprise a code workspace tool 112 for previewing, editing (e.g., manually editing) and/or downloading the code 110. The code workspace tool 112 may be configured to automatically deploy the code 110 in an application.

The UI design representation 102 may comprise a graphical representation, such as a simplified and/or schematic representation, of the UI design. The UI design representation 102 may outline a structural arrangement of one or more interface elements (e.g., buttons, text areas, search bars, navigation components, etc.) of the UI design. In some examples, the UI design representation 102 (e.g., at least one of a wireframe, a UI mockup, a UI prototype, etc.) may be created using a first design tool. For example, the first design tool may comprise a wireframe design tool (e.g., at least one of Figma, Adobe® Sketch, etc.) and/or a graphics design tool (e.g., Adobe Photoshop®, etc.). In some examples, the UI design representation 102 may be hand-drawn (e.g., the UI design representation 102 may comprise a scan of a hand-drawn visual outline of the UI design and/or a visual UI design drawn using a drawing pad). The UI design representation 102 may comprise a wireframe (e.g., low-fidelity wireframe, high-fidelity wireframe, etc.), a UI mockup, a UI prototype, a UI prototype, an artificial intelligence (AI)-generated UI sketch (which may be generated based upon a prompt indicative of a text description and/or a rough drawing of the UI design, for example), and/or other type of (visual) UI design representation.

The UI design representation 102 may be identified based upon a code generation request indicative of the UI design representation 102. The code generation request may be a request (e.g., an automated request or a manually submitted request by a user) to convert the UI design representation 102 to code. The code generation request may be received via a design selection interface 162 (shown in FIG. 1B). FIG. 1B illustrates the code generation request interface 162 being displayed (by the code generation tool, for example) on a first client device 100. The first client device 100 may comprise at least one of a laptop, a desktop computer, a phone, a computer, a wearable device, a smart device, a television, any other type of computing device, hardware, etc. The design selection interface 162 may comprise a web address entry interface for entering a web address associated with the UI design representation 102. For example, the web address entry interface may comprise a text field 164 for a user of the first client device 100 to enter the web address (e.g., https://www.designsourcedata.example/1). The web address may be directed to an internet resource that provides access to the UI design representation 102. The design selection interface 162 may comprise a design attachment interface 166 for the user to attach a design file comprising the UI design representation 102. For example, the design attachment interface may comprise an attachment selectable input 166 that when selected triggers the first client device 100 to display an interface usable to find the design file stored on the first client device 100 and/or select the design file to be attached to the code generation request. The code generation request may be submitted by the first client device 100 (and/or transmitted to the code generation tool, for example) in response to a selection of a selectable input 168 of the design selection interface 162.

The profile determination module 104 may determine the design profile 106 based upon design information associated with the UI design representation 102. In a scenario in which the code generation request comprises the design file, the design information may be extracted from the design file in response to receiving the code generation request. In a scenario in which the code generation request comprises the web address, the design information may be retrieved by the code generation tool from the internet resource in response to receiving the code generation request.

The design information (used to determine the design profile 106) may comprise structured design data representative of the UI design representation 102 and/or a design image representative of the UI design representation 102. The profile determination module 104 may check for availability of the structured design data (e.g., a JavaScript Object Notation (JSON) file and/or other type of structured file output by a design tool (e.g., the first design tool) used to design the UI design representation 102. In response to determining that the structured design data for the UI design representation 102 is available, the profile determination module 104 may use the structured design data to determine the design profile 106 (and/or may not use the design image to determine the design profile 106).

In response to determining that the structured design data for the UI design representation 102 is not available, the profile determination module 104 may use the design image to determine the design profile 106. The design image may comprise a screenshot of an application (e.g., at least one of a webpage, a mobile application, etc.). For example, the profile determination module 104 may comprise an image processing module (e.g., an AI-driven image processing module) configured to analyze the design image to identify interface elements of the UI design representation 102, determine attributes associated with the interface elements, and/or generate the design profile 106 to be indicative of the interface elements and/or the attributes associated with the interface elements.

The design profile 106 may be indicative of a hierarchy of interface element placement throughout the UI design representation 102. For example, the design profile 106 may be indicative of depth-levels and/or relationships (e.g., parent-child relationships) associated with interface elements of the UI design representation 102. The profile determination module 104 may perform a hierarchical interface element analysis (e.g., depth first search (DFS)) to determine the depth-levels and/or the relationships. For example, the hierarchical interface element analysis may comprise traversing the UI design representation 102, breaking down the UI design representation 102 into interface elements, and/or recognizing the relationships and/or the depth-levels associated with the interface elements.

The design profile 106 may have (and/or may be structured and/or represented using) a first format (e.g., a file and/or data interchange format), such as JavaScript Object Notation (JSON) and/or other formats. Formatting the design profile 106 according to the first format may provide for improved processing, analysis, and/or rendering performed by the code generation module 108 and/or the code workspace tool 112 to generate and/or use the code 110.

The design profile 106 may be indicative of interface elements of the UI design representation 102 and/or sets of attributes associated with the interface elements. For example, the design profile 106 may be indicative of a first set of attributes (e.g., a first set of one or more attributes) of a first interface element of the UI design representation 102, a second set of attributes (e.g., a second set of one or more attributes) of a second interface element of the UI design representation 102, a third set of attributes (e.g., a third set of one or more attributes) of a third interface element of the UI design representation 102 and/or other sets of attributes of other interface elements of the UI design representation 102. An interface element (e.g., at least one of the first interface element, the second interface element, etc.) may comprise a user interface component (e.g., a functional component that can be interacted with by a user), such as at least one of a button, a tab set, a tab, a tab navigation element, an icon, a search bar, a menu, a radio button, a text area, a text input, a date picker, a form element, a slider, a toggle button, an advanced table, a toolbar, an avatar, a timeline, etc. Alternatively and/or additionally, an interface element (e.g., at least one of the first interface element, the second interface element, etc.) may comprise a design, layout and/or structural element (for layout structuring of the UI design representation 102, for example), such as at least one of a frame, a rectangle, an ellipse, a line, text, a group, a vector, an instance, etc. An interface element (e.g., at least one of the first interface element, the second interface element, etc.) may comprise a component (e.g., a frontend component, such as a React component and/or other frontend component) and/or may be stored in a component library (e.g., Material UI (MUI) library and/or other library). An interface element (e.g., at least one of the first interface element, the second interface element, etc.) may comprise a micro frontend (MFE).

The first set of attributes may comprise a first position of the first interface element, a first depth-level of the first interface element, a first interface element tag 140 (shown in FIG. 1D) of the first interface element, one or more first relationships (e.g., one or more parent-child relationships) between the first interface element and one or more first related interface elements, and/or other information associated with the first interface element, such as at least one of a first maximum x-coordinate (xvalue), a first maximum y-coordinate (yvalue), a first background color, a first set of size dimensions (e.g., a set of one or more size dimensions, such as at least one of height, width, etc., of the first interface element), a first padding attribute, a first stroke attribute, a first layout positioning attribute, a first layout mode, a first corner radius, a first stroke weight, a first resolution percentage, a first component styling, a first set of layout data, etc. The one or more first relationships may be indicative of a first parent interface element (that the first interface element is a child of, for example) and/or one or more first child interface elements (that the first interface element is a parent of, for example). The first position may be indicative of one or more coordinates (e.g., x and/or y coordinate) corresponding to a spatial location of the first interface element. The first position may be indicative of a position of the first interface element relative to the first parent interface element, such as a distance of the first interface element from the first parent interface element. A rendering position may be determined by combining the first position with a position of the first parent interface element, and the first interface element may be rendered at the rendering position. The first interface element tag 140 may be indicative of a first element type of the first interface element (e.g., button, input, heading, etc.) and/or a first component name (and/or identifier) of the first interface element. One or more attributes (e.g., at least one of at least one of the first component styling, the first set of layout data, etc.) of the first set of attributes may be determined by using a function (e.g., getsxproperty function and/or other function) to extract the one or more attributes from a node (e.g., JSON node) of the design profile 106 (e.g., the function may utilize one or more inputs such as at least one of the first component name, the first maximum x-coordinate, the first maximum x-coordinate, etc.).

The second set of attributes may comprise a second position of the second interface element, a second depth-level of the second interface element, a second interface element tag 142 (shown in FIG. 1D) of the second interface element, one or more second relationships (e.g., one or more parent-child relationships) between the second interface element and one or more second related interface elements, and/or other information associated with the second interface element, such as at least one of a second maximum x-coordinate (xvalue), a second maximum y-coordinate (yvalue), a second background color, a second set of size dimensions, a second padding attribute, a second stroke attribute, a second layout positioning attribute, a second layout mode, a second corner radius, a second stroke weight, a second resolution percentage, a second component styling, a second set of layout data, etc. The one or more second relationships may be indicative of a second parent interface element (that the second interface element is a child of, for example) and/or one or more second child interface elements (that the second interface element is a parent of, for example). The second position may be indicative of one or more coordinates of the second interface element (relative to the second parent interface element, for example). The second interface element tag 142 may be indicative of a second element type of the second interface element (e.g., button, input, heading, etc.) and/or a second component name (and/or identifier) of the second interface element. One or more attributes (e.g., at least one of at least one of the second component styling, the second set of layout data, etc.) of the second set of attributes may be determined by using a function (e.g., getsxproperty function and/or other function) to extract the one or more attributes from a node (e.g., JSON node) of the design profile 106 (e.g., the function may utilize one or more inputs such as at least one of the second component name, the second maximum x-coordinate, the second maximum x-coordinate, etc.).

The code generation module 108 may use a code template catalog 138 (shown in FIG. 1C) to generate the code 110. The code template catalog 138 may comprise code template entries comprising code templates and/or interface element tags associated with the code templates. For example, the code template catalog 138 may comprise a first code template entry 120, a second code template entry 122, a third code template entry 124 and/or one or more other code template entries. The first code template entry 120 may comprise a first code template 128 and/or an interface element tag 126 associated with the first code template 128. The second code template entry 122 may comprise a second code template 132 and/or an interface element tag 130 associated with the second code template 132. The third code template entry 124 may comprise a third code template 136 and/or an interface element tag 134 associated with the third code template 136.

FIG. 1C illustrates use of the code template catalog 138 to train a machine learning model using a training module 116 to generate a trained code generation model 118. The training module 116 may use code templates (e.g., at least one of the first code template 128, the second code template 132, the third code template 136, etc.) and/or interface elements tag (e.g., interface element tag 126, 130 and/or 135) of the code template catalog 138 to train the trained code generation model 118 to dynamically generate code for various given interface element tags. In response to generating the trained code generation model 118, the trained code generation model 118 may be loaded into the code generation module 108.

The code template catalog 138 may be generated and/or updated to be in accordance with and/or compatible with a first design environment (e.g., a custom design environment) associated with a first entity (e.g., a first organization, a first company, a first brand, a first web site, etc.). For example, a code template of the code template catalog 138 may be generated (manually and/or automatically, for example) to be in adherence to one or more first guidelines (e.g., user interface design guidelines) and/or one or more first standards associated with the first design environment. The one or more first guidelines may be indicative of one or more parameters (e.g., at least one of color palette, typography, iconography, layout structure, interface element sizing, margin sizing, alignment guidelines, grid systems, etc.) associated with interface elements to be used in the first design environment (e.g., one or more websites, mobile applications, etc. associated with the first entity). A code template of the code template catalog 138 may be generated (manually and/or automatically, for example) to be compatible with one or more first component libraries associated with the first design environment. The trained code generation model 118 may learn to generate code (for interface elements) that adheres to the one or more first guidelines and/or the one or more first standards associated with the first design environment and/or that is compatible with the one or more first component libraries.

The code template catalog 138 may be integrated with an interface element data store of the first design environment (e.g., a database of interface elements being used in the first design environment), a MFE data store of the first design environment (e.g., a database of MFEs being used in the first design environment) and/or a design system of the first design environment (e.g., a design system customized to user experience guidelines associated with the first design environment). The code template catalog 138 may comprise code templates corresponding to interface elements stored in the interface element data store and/or code templates corresponding to MFEs stored in the MFE data store. A catalog maintenance module may scan the interface elements data store to check for one or more changes to the interface elements data store (e.g., new interface elements, removed interface elements, etc.) and/or may update the code template catalog 138 based upon the one or more changes, for example by generating a code template entry for a new interface element added to the interface elements data store and/or storing the code template entry in the code template catalog 138 and/or by removing a code template entry, from the code template catalog 138, that corresponds to an interface element that was removed from the interface elements data store (to prevent inclusion of deprecated and/or outdated interface elements, for example). The catalog maintenance module may scan the MFE data store to check for one or more changes to the MFE data store and/or may update the code template catalog 138 based upon the one or more changes, for example by generating a code template entry for a new MFE added to the MFE data store and/or storing the code template entry in the code template catalog 138 and/or by removing a code template entry, from the code template catalog 138, that corresponds to an MFE that was removed from the MFE data store (to prevent inclusion of deprecated and/or outdated MFEs, for example). The catalog maintenance module may track activity of and/or subscribe to the design system to determine a delta associated with the design system, and/or may make updates to the code template catalog 138 (and/or to the interface element data store and/or the MFE data store) based upon the delta (to keep the code template catalog 138 current, for example). In response to updating the code template catalog 138, the training module 116 may use an updated version of the code template catalog 138 (with additional or removed code template entries, for example) to train and/or update the trained code generation model 118, such that the trained code generation model 118 (and/or code generated by the trained code generation model 118) is up to date with latest design guidelines and/or component libraries of the first design environment.

The code 110 may be generated (by the trained code generation model 118, for example) based upon a set of matching code templates 148 (shown in FIG. 1D) of the code template catalog 138. FIG. 1D illustrates a matching code template determination module 146 being used to determine the set of matching code templates 138 based upon the design profile 106. The matching code template determination module 146 may analyze the code template catalog 138 based upon the design profile 106 to determine the set of matching code templates 138. For example, the matching code template determination module 146 may compare interface element tags indicated by the design profile 106 with interface element tags of the code template catalog 138, and/or determine the set of matching code templates 138 based upon the comparisons.

The matching code template determination module 146 may determine that the second code template 132 matches the first interface element of the UI design representation 102, and/or may include the second code template 132 in the set of matching code templates 148. For example, the matching code template determination module 146 may determine that the second code template 132 matches the first interface element based upon a determination that the first interface element tag 140 (associated with the first interface element) of the design profile 106 matches the interface element tag 130 associated with the second code template 132. The matching code template determination module 146 may determine that the first interface element tag 140 matches the interface element tag 130 based upon a determination that at least a portion of the first interface element tag 140 is identical to and/or is similar to (e.g., has a similar meaning and/or definition) at least a portion of the interface element tag 130. In a scenario in which the first interface element corresponds to a frame, the matching code template determination module 146 may determine that the first interface element tag 140 matches the interface element tag 130 based upon the interface element tag 130 comprising “FRAME” (and/or other text that is indicative of a frame) and the first interface element tag 140 comprising “FRAME” (and/or other text that is indicative of a frame).

The matching code template determination module 146 may determine that the third code template 136 matches the second interface element of the UI design representation 102, and/or may include the third code template 136 in the set of matching code templates 148. For example, the matching code template determination module 146 may determine that the third code template 136 matches the second interface element based upon a determination that the second interface element tag 142 (associated with the second interface element) of the design profile 106 matches the interface element tag 134 associated with the third code template 136. The matching code template determination module 146 may determine that the second interface element tag 142 matches the interface element tag 134 based upon a determination that at least a portion of the second interface element tag 142 is identical to and/or is similar to (e.g., has a similar meaning and/or definition) at least a portion of the interface element tag 134. In a scenario in which the second interface element corresponds to a button, the matching code template determination module 146 may determine that the second interface element tag 142 matches the interface element tag 134 based upon the interface element tag 134 comprising “BUTTON” (and/or other text that is indicative of a button) and the second interface element tag 142 comprising “BUTTON” (and/or other text that is indicative of a button).

The matching code template determination module 146 may determine that the first code template 128 matches the third interface element of the UI design representation 102, and/or may include the first code template 128 in the set of matching code templates 148.

In response to analyzing the code template catalog 138 based upon an interface element tag of an interface element of the design profile 106 and determining that a code template entry with a matching interface element tag (e.g., identical to and/or similar to the interface element tag) is not available, the matching code template determination module 146 may check the code template catalog 138 for a matching code template based upon similarity to the interface element relative to functionality and/or one or more other features. The matching code template determination module 146 may determine a similarity score based upon an extent to which functionality and/or the one or more other features is similar between the interface element and the code template. The matching code template determination module 146 may determine that the code template (e.g., the second code template 132) matches the interface element (e.g., the first interface element) based upon the similarity score meeting a threshold (which may be configurable).

The code generation module 108 may generate a plurality of sets of code associated with a plurality of interface elements of the UI design representation 102. The plurality of sets of code may comprise a first set of code 156 (shown in FIG. 1E) associated with the first interface element, a second set of code 160 (shown in FIG. 1F) associated with the second interface element, a third set of code 163 (shown in FIG. 1G) associated with the third interface element and/or one or more other sets of code associated with one or more other interface elements of the UI design representation 102.

The code generation module 108 may use a code template of the set of matching code templates 148 to generate a set of code for an interface element of the UI design representation 102. For example, based upon the determination that the second code template 132 matches the first interface element of the UI design representation 102, the code generation module 108 may generate a first set of code 156 for the first user element based upon the second code template 132. Based upon the determination that the third code template 136 matches the second interface element of the UI design representation 102, the code generation module 108 may generate the second set of code 160 for the second user element based upon the third code template 136. Based upon the determination that the first code template 128 matches the third interface element of the UI design representation 102, the code generation module 108 may generate the third set of code 163 for the third user element based upon the first code template 128.

FIG. 1E illustrates generation of the first set of code 156 using the second code template 132. One or more code generation operations 154 may be performed (by the code generation module 108 and/or the trained code generation model 118, for example) based upon the second code template 132 and/or one or more attributes 152 (e.g., at least one of the first maximum x-coordinate, the first maximum y-coordinate, the first background color, the first set of size dimensions, the first padding attribute, the first stroke attribute, the first layout positioning attribute, the first layout mode, the first corner radius, the first stroke weight, etc.) of the first set of attributes of the first interface element of the UI design representation 102 to generate the first set of code 156. The one or more code generation operations 154 may comprise applying the one or more attributes 152 to the second code template 132 to generate the first set of code 156. The one or more code generation operations 154 may comprise dynamically replacing one or more placeholders in the second code template 132 with one or more values indicated by and/or determined based upon the one or more attributes 152 (e.g., at least one of a height placeholder in the second code template 132 may be replaced with a height value indicated by the first set of size dimensions, a background color placeholder in the second code template 132 may be replaced with the first background color, etc.). The first set of code 156 may be indicative of the one or more attributes 152 and/or one or more values determined based upon the one or more attributes 152.

FIG. 1F illustrates generation of the second set of code 160 using the third code template 136. One or more code generation operations 170 may be performed (by the code generation module 108 and/or the trained code generation model 118, for example) based upon the third code template 136 and/or one or more attributes 158 (e.g., at least one of the second maximum x-coordinate, the second maximum y-coordinate, the second background color, the second set of size dimensions, the second padding attribute, the second stroke attribute, the second layout positioning attribute, the second layout mode, the second corner radius, the second stroke weight, etc.) of the second set of attributes of the second interface element of the UI design representation 102 to generate the second set of code 160. The one or more code generation operations 170 may comprise applying the one or more attributes 158 to the third code template 136 to generate the second set of code 160. The one or more code generation operations 170 may comprise dynamically replacing one or more placeholders in the third code template 136 with one or more values indicated by and/or determined based upon the one or more attributes 158 (e.g., at least one of a height placeholder in the third code template 136 may be replaced with a height value indicated by the second set of size dimensions, a background color placeholder in the third code template 136 may be replaced with the second background color, etc.). The second set of code 160 may be indicative of the one or more attributes 158 and/or one or more values determined based upon the one or more attributes 158.

FIG. 1G illustrates generation of the third set of code 163 using the third code template 136. One or more code generation operations 161 may be performed (by the code generation module 108 and/or the trained code generation model 118, for example) based upon the first code template 128 and/or one or more attributes 159 of the third set of attributes of the third interface element of the UI design representation 102 to generate the third set of code 163. Other sets of code of the plurality of sets of code may be generated using one or more of the techniques provided herein with respect to the first set of code 156, the second set of code 160 and/or the third set of code 163.

Code for different interface elements of the UI design representation 102 may be arranged and/or organized throughout various positions of the code 110 based upon one or more attributes associated with the interface elements, such as relationship (e.g., the one or more first relationships, the one or more second relationships, etc.), position (e.g., the first position, the second position, etc.), depth-level (e.g., the first depth-level, the second depth-level, etc.), and/or one or more other attributes. For example, the code generation module 108 may determine a first code position in the code 110 for the first set of code 156 based upon the first depth-level, the first position and/or the one or more first relationships. For example, the first code position for the first set of code 156 may be determined (based upon the first depth-level, which may be indicative of a hierarchical ranking of the first interface element in the UI design representation 102, for example) such that the first set of code 156 is arranged relative to other interface elements according to the hierarchical ranking of the first interface element. The first position (e.g., spatial position) of the first interface element may be mapped to the first code position. The first code position for the first set of code 156 may be determined to reflect the one or more first relationships associated with the first interface element. The first set of code 156 may be arranged in the code 110 such that the first set of code 156 is nested within a set of code corresponding to the first parent interface element (based upon the first interface element being a child of the first parent interface element, for example). The first set of code 156 may be arranged in the code 110 such that one or more sets of code corresponding to the one or more first child interface elements (that the first interface element is a parent of, for example) are nested within the first set of code 156.

The code generation module 108 may determine a second code position in the code 110 for the second set of code 160 based upon the second depth-level, the second position and/or the one or more second relationships. For example, the second code position for the second set of code 160 may be determined (based upon the second depth-level, which may be indicative of a hierarchical ranking of the second interface element in the UI design representation 102, for example) such that the second set of code 160 is arranged relative to other interface elements according to the hierarchical ranking of the second interface element. The second position (e.g., spatial position) of the second interface element may be mapped to the second code position. The second code position for the second set of code 160 may be determined to reflect the one or more second relationships associated with the second interface element. The second set of code 160 may be arranged in the code 110 such that the second set of code 160 is nested within a set of code corresponding to the second parent interface element (based upon the second interface element being a child of the second parent interface element, for example). The second set of code 160 may be arranged in the code 110 such that one or more sets of code corresponding to the one or more second child interface elements (that the second interface element is a parent of, for example) are nested within the second set of code 160.

In an exemplary scenario, the first interface element may correspond to a frame 167 (shown in FIG. 1H) and the second interface element may correspond to a button 165 (shown in FIG. 1H) in the frame 167. For example, the design profile 102 may indicate that the first interface element (e.g., the frame 167) is a parent of the second interface element (e.g., the button 165). In the exemplary scenario, the first set of code 156 may be arranged relative to the second set of code 160 in the code 110 based upon the first interface element (e.g., the frame 167) being the parent of the second interface element (e.g., the button 165). For example, the second set of code 160 may be nested within the first set of code 156 based upon the first interface element (e.g., the frame 167) being the parent of the second interface element (e.g., the button 165).

An optimization process may be performed on a first version of the code 110 to generate an optimized version of the code 110. The first version of the code 110 may comprise a first data structure that stores file names and corresponding content, and/or may maintain a clear separation of concerns by organizing different types of code (e.g., JavaScript, Typescript, Cascading Style Sheets (CSS), etc.) into dedicated directories and/or files. The optimization process may comprise scanning the first data structure and/or the code 110 to detect and/or remove one or more unwanted fragments from the first data structure and/or the code 110, such as dead code, one or more duplicates, one or more empty tags, one or more self-closing components, and/or other unwanted fragments. An empty tag of the one or more empty tag may correspond to an interface element (e.g., Hypertext Markup Language (HTML) element) without content (e.g., the interface element may be generated when design tools represent layout elements and/or placeholders). In some examples, the one or more empty tags may comprise <div></div>, <span></span>. A self-closing component of the one or more self-closing components may correspond to an interface element without children (e.g., <MyComponent/> in Javascript XML (JSX)). The code generation module 108 may generate a second data structure (e.g., componentSetArray) which may be rendered dynamically and/or used to track utilized interface elements during code generation. The second data structure may drive creation of one or more import statements (to ensure interface elements are correctly imported without duplicates, for example).

In response to generating the code 110, the code generation module 108 may provide the code 110 to the code workspace tool 112. The code workspace tool 112 may provide the code 110 to a client device (e.g., the first client device 100 and/or one or more other client devices) and/or display a representation of the code 110 on the client device. The code workspace tool 112 may generate a visual design representation (e.g., a visual representation of the UI design representation 102) based upon the code 110 and/or display the visual design representation on the client device. The visual design representation may be rendered according to the code 110.

The code workspace tool 112 may display a code workspace interface 174 on the first client device 100 for previewing, editing (e.g., manually editing) and/or downloading the code 110. FIG. 1H illustrates the first client device 100 displaying the code workspace interface 174. The code workspace interface 174 may comprise a code representation window 182 displaying a representation of the code 110 and/or a design representation window 184 displaying the visual design representation. The code representation window 182 may comprise a scroll bar (and/or other navigation control element) for navigating throughout various parts of the representation of the code 110. Some and/or all of the code 110 may be selected within the code representation window 182 and/or copied (to be pasted in an existing codebase, for example). The design representation window 184 may comprise a scroll bar (and/or other navigation control element) for navigating throughout various parts of the visual design representation. A first portion of the visual design representation corresponding to the first interface element (e.g., a portion of the visual design representation comprising the frame 167 in FIG. 1H) may be rendered according to the first set of code 156. A second portion of the visual design representation corresponding to the second interface element (e.g., a portion of the visual design representation comprising the button 165 in FIG. 1H) may be rendered according to the second set of code 160. In some examples, based upon the button 165 being a child of the frame 167, the button 165 may be rendered to have a position that is determined based upon the second position and a position (e.g., the first position) of the frame 167 (e.g., coordinates of the button 165 are determined relative to the position of the frame 167), thereby providing for accurate interface element positioning without compromising on page responsive design. A third portion of the visual design representation corresponding to the third interface element (e.g., a portion of the visual design representation comprising a rectangle 169 in FIG. 1H) may be rendered according to the third set of code 163.

The code workspace interface 174 may comprise a design selection selectable input 171 for selecting a different UI design representation (different than the UI design representation 102, for example). For example, the design selection interface 162 may be displayed on the first client device 100 in response to a selection of the design selection selectable input 171 (e.g., (e.g., the design selection interface 162 may be used to select the different UI design representation and/or submit a subsequent code generation request for the different UI design representation).

The code workspace interface 174 may comprise one or more display setting selectable inputs, such as a first display setting selectable input 176 associated with a first display setting for the code workspace interface 174, a second display setting selectable input 178 associated with a second display setting for the code workspace interface 174 and/or a third display setting selectable input 172 associated with a third display setting for the code workspace interface 174. In some examples, the first display setting, in which the code workspace interface 174 concurrently displays and/or provides access to the code representation window 182 and the design representation window 184, is activated in response to a selection of the first display setting selectable input 176. FIG. 1H illustrates an example of the code workspace interface 174 when the first display setting is activated. In some examples, the second display setting, in which the code workspace interface 174 displays the design representation window 184 without displaying the code representation window 182, is activated in response to a selection of the second display setting selectable input 178. FIG. 1K illustrates an example of the code workspace interface 174 when the second display setting is activated. In some examples, the third display setting, in which the code workspace interface 174 displays the code representation window 182 without displaying the design representation window 184, is activated in response to a selection of the third display setting selectable input 172.

The code representation window 182 may comprise a text editor module for editing the code 110. For example, the text editor module may monitor for user input events. In response to detecting a user input event (e.g., one or more key presses on a keyboard, audio input via a microphone, etc.), the text editor module may perform one or more edits (e.g., deletion of one or more parts of the code 110, adding new text to the code) to the code 110 and/or may update the code 110 dynamically (to display an updated version of the code 110 incorporating the one or more edits, for example). In response to editing the code 110, the visual design representation may be updated (e.g., one or more interface elements of the visual design representation may be modified in accordance with the one or more edits) and/or the design representation window 184 may display the updated visual design representation.

The design representation window 184 may comprise a design editor module for editing the UI design representation 102 and/or the visual design representation. The design editor module may monitor for user input events. In response to detecting a user input event, the design editor module may perform one or more edits to the visual design representation and/or may update the visual design representation dynamically (to display an updated version of the visual design representation incorporating the one or more edits, for example). In an exemplary scenario in which the one or more edits comprise changing a location of an interface element of the UI design representation 102, the user input event may correspond to an event in which a user drags (using at least one of a mouse cursor, a touchscreen, etc.) the interface element from an initial location in the design representation window 184 to a new location in the design representation window 184. In an exemplary scenario in which the one or more edits comprise deleting an interface element, the user input event may correspond to an event in which a user selects the interface element causing the design representation window 184 to display one or more modification options and/or the user selects a modification option to remove the interface element. The code 110 may be updated based upon the one or more edits to the visual design representation (e.g., the code 110 may be updated to be indicative of the new location and/or to not comprise a set of code corresponding to the deleted interface element) to generate updated code and/or the code representation window 182 may display the updated code.

The code workspace interface 174 may comprise a download selectable input 180 for downloading the code 110 (and/or a portion of the code 110). For example, in response to a selection of the download selectable input 180, the code workspace tool 112 may provide the code 110 to the first client device 110. The code workspace tool 112 may provide a frontend package comprising the code 110 (e.g., frontend code) to the first client device 110. In some examples, the frontend package may comprise a MFE (e.g., a deployable MFE). The frontend package may be built, packaged and/or deployable. For example, the frontend package may be executed (immediately, for example) by an application (e.g., at least one of a webpage, a mobile application, etc.) without requiring further modification and/or invention. The code workspace tool 112 may package the code 110 into a deployable directory with compiled scripts, styles, and/or assets that may be integrated in various deployment environments.

The code workspace tool 112 may organize code files of the code 110 in directories of the frontend package based upon file type (e.g., JavaScript, Typescript, Cascading Style Sheets (CSS), etc.). The code workspace tool 112 may generate the frontend package to comprise one or more configuration files that enable the code 110 (and/or the frontend package) to be executed as is (by a developer machine, for example). For example, the one or more configuration files may comprise all configuration files needed for the code 110 (and/or the frontend package) to be executed as is (without requiring an additional configuration and/or driver installed on the developer machine, for example). The frontend package may comprise one or more placeholders for editing the code 110 and/or the frontend package and/or supplementing the code 110 and/or the frontend package with supplemental details (e.g., variables and/or other information of a development environment of the developer machine and/or a production environment where the frontend package is deployed, for example). For example, a placeholder may serve as a predefined marker that may be replaced with an environment and/or production variable. The frontend package may comprise one or more unit test cases for the code 110.

One or more settings associated with the frontend package may be selected via a package settings interface 190. FIG. 1I illustrates the first client device 100 displaying the package settings interface 190 (in response to a selection of the download selectable input 180, for example). The package settings interface 190 may comprise a UI technology selection interface 192 for selecting a preferred UI technology among a plurality of UI technologies (e.g., React and/or one or more other UI technologies), a language selection interface 194 for selecting a preferred language (e.g., coding language) among a plurality of languages (e.g., Javascript, Typescript, CSS, etc.), a design system selection interface 196 for selecting a preferred design system among a plurality of design systems, and/or a framework selection interface 199 for selecting a preferred framework among a plurality of frameworks. In response to a selection of an export selectable input 198, the frontend package may be generated to according to one or more selected and/or preferred settings (e.g., the preferred UI technology, the preferred language, the preferred design system, the preferred framework, etc.), and/or may be provided to the first client device 100. The first client device 100 may be provided with a message (e.g., a readme file for a user) with usage details and/or instructions associated with the frontend package.

In response to a selection of an automatic deployment selectable input 173, the code workspace tool 112 may automatically deploy the code 110 (and/or the frontend package) in an application (e.g., at least one of a webpage, a mobile application, etc.). In response to selecting the automatic deployment selectable input 173, the code workspace interface 174 may display a target deployment interface usable to select an application and/or a location of the application in which to deploy the code 110. A request indicative of a first application may be received via the target deployment interface. The code workspace tool 112 may deploy the code 110 (and/or the frontend package) in response to the request. For example, the code workspace tool 112 may serve the frontend package to a computer hosting the first application, which may integrate the frontend package into a runtime environment of the first application. The code 110 (and/or the frontend package) may be executed to render at least a portion of a frontend of the first application (via a graphical user interface of a client device accessing the first application, for example). The request may be indicative of a web address of a first webpage (e.g., the target deployment interface may comprise a field into which the web address is entered). The code 110 (and/or the frontend package) may be executed to render at least a portion of a frontend of the first webpage (via a graphical user interface of a client device accessing the first webpage, for example).

A sanitization process may be performed to check for one or more problematic interface elements of the UI design representation 102. The sanitization process may comprise analyzing (using the matching code template determination module 146, for example) the code template catalog 138 and, for each interface element of one, some and/or all interface elements of the UI design representation 102, checking whether there is a matching code template for the interface element in the code template catalog 138. A problematic interface element may be considered to be an interface element for which the matching code template determination module 146 cannot find a matching code template from the code template catalog 138 (e.g., lack of a matching code template may indicate that the problematic interface element potentially may not adhere to the one or more first guidelines and/or the one or more first standards and/or may not be compatible with the one or more first component libraries associated with the first design environment). In response to detecting one or more problematic interface elements of the UI design representation 102, the code workspace interface 174 may display a warning 188 indicative of the one or more problematic interface elements. FIG. 1J illustrates the first client device 100 displaying the warning 188, which may comprise an auto-correct selectable input 197. In response to a selection of the auto-correct selectable input 197, one or more modifications may be made in the code 110, the UI design representation 102 and/or the design profile 106 to modify the one or more problematic interface elements to adhere to the one or more first guidelines and/or the one or more first standards and/or may be compatible with the one or more first component libraries associated with the first design environment.

The code workspace interface 174 may comprise a design portion selection interface for selecting a portion of the UI design representation 102. FIG. 1K illustrates the code workspace interface 174 displaying a generate code selectable input 195 of the design portion selection interface for selecting a portion of interest 193 of the visual design representation, which may correspond to a portion of the UI design representation 102. The generate code selectable input 195 may be displayed in response to a cursor hovering over the portion of interest 193 (and/or in response to a selection of a location within the portion of interest 193). The code workspace interface 174 may comprise one or more selection tools (e.g., a Marquee selection tool and/or other selection tools) for selecting one or more interface elements to be included in the portion of interest 193. In an exemplary scenario shown in FIG. 1K, the portion of interest 193 may comprise an interface element corresponding to a header.

A request indicative of the portion of interest 193 may be received (in response to a selection of the generate code selectable input 195, for example). In response to the request, a set of code corresponding to the portion of interest 193 of the visual design representation may be generated and/or provided to the first client device 100. Generation of the set of code may comprise extracting a subset of code, corresponding to the portion of interest 193, from the code 110 (e.g., the set of code may comprise the subset of code extracted from the code 110). FIG. 1L illustrates the code representation window 182 being updated to comprise the set of code (e.g., the subset of code) and/or the design representation window 184 being updated to display a representation of the portion of interest 193. In response to a selection of the download selectable input 180, the code workspace tool 112 may provide a second frontend package (e.g., a built, packaged and/or deployable frontend package) comprising the set of code (e.g., the subset of code) to the first client device 110 (and/or the code workspace interface 174 may display the package settings interface 190 for selecting one or more settings of the second frontend package). In response to a selection of the automatic deployment selectable input 173, the code workspace tool 112 may automatically deploy the set of code (and/or the second frontend package) in an application (and/or the code workspace interface 174 may display the target deployment interface for selecting the application and/or a location of the application in which to deploy the code 110).

In some examples, the UI design representation 102 may comprise a plurality of UI design representation screens (comprising UI design representation screens corresponding to a plurality of webpages of the UI design representation 102, for example). FIG. 1M illustrates the design selection interface 162 display a design screen selection interface 121 for selecting one or more screens of the plurality of UI design representation screens to include in the design profile 106. The design screen selection interface 121 may be displayed in response to determining that the UI design representation 102 comprises the plurality of UI design representation screens (which may be determined in response to receiving the code generation request). The design screen selection interface 121 may comprise a first selectable screen item 123 for selecting a first UI design representation screen of the plurality of UI design representation screens and/or a second selectable screen item 123 for selecting a second UI design representation screen of the plurality of UI design representation screens. In response to a selection of a generate selectable input 127, the design profile 106 and/or the code 110 may be generated to include one or more selected UI design representation screens of the plurality of UI design representation screens.

FIG. 1N illustrates a representation 131 indicative of hierarchical relationships between tags of the design profile 106. The tags may comprise a tag “DOCUMENT” associated with the UI design representation 102 (e.g., a parent tag, of the UI design representation 102, that may be indicative of a type of canvas associated with the UI design representation 102), a tag “CANVAS” associated with the UI design representation 102 (e.g., a sub-parent tag, of the UI design representation 102, that may be indicative of a type of page associated with the UI design representation 102), and/or interface element tags (e.g., interface element tag “FRAME”, interface element tag “RECTANGLE”, etc.) associated with interface elements (e.g., user interface components and/or design, layout and/or structural elements) of the design profile 106. The tag “CANVAS” may be a child of the tag “DOCUMENT” and/or may be a parent to at least one of the interface element tag “FRAME”, the interface element tag “RECTANGLE”, etc. The interface element tag “FRAME” may be a parent to at least one of interface element tag “Tab Set”, interface element tag “Tags”, etc. An interface element tag “GROUP” may be a parent to at least one of interface element tag “Slider”, interface element tag “Toggle Button”, etc.

FIG. 1O illustrates a representation 133 indicative of hierarchical relationships between tags of the design profile 106. The tags may comprise a tag 135 “DOCUMENT” associated with the UI design representation 102 (e.g., a parent tag, of the UI design representation 102, that may be indicative of a type of canvas associated with the UI design representation 102), a tag 137 “CANVAS” associated with the UI design representation 102 (e.g., a sub-parent tag, of the UI design representation 102, that may be indicative of a type of page associated with the UI design representation 102), a first set of interface element tags 139 and/or a second set of interface element tags 141. The tag 135 “DOCUMENT” may be a parent to the tag 137 “CANVAS”, which may be a parent to the first set of interface element tags 139. The first set of interface element tags 139 may comprise Core Design System Material-UI (CDS MUI) Library Components and/or other types of interface element tags. An interface element tag “FRAME” of the first set of interface element tags 139 may be a parent to the second set of interface element tags 141.

The UI design representation 102 may be an (older) interface design of an application that was built using existing, legacy and/or end-of-life (EOL) tech stacks and/or design. The design information (used to determine the design profile 106 and/or generate the code 110) may comprise a screenshot of a page (e.g., a webpage) of the application. The UI design representation 102 may not be in adherence to the one or more first guidelines and/or one or more the first standards associated with the first design environment. The code generation tool may automate the process of generating updated frontend code (e.g., the code 110) to be in accordance with updates (e.g., guideline changes, user interface style changes, component library changes, changes to tech stack, etc.) to the first design environment.

The code generation tool may be used to update interfaces of a plurality of applications of the first design environment. For example, the code generation tool may collect design information (e.g., structured design data and/or design images such as application screenshots) associated with the plurality of applications, generate (updated and/or more stable) code using the code template catalog 138 and/or the trained code generation model 118 (which are updated to be kept in accordance with the one or more first guidelines and/or one or more the first standards, for example), and/or provide the generated code to be deployed in the plurality of applications. By using the code template catalog 138 and/or the trained code generation model 118 to generate the code for the plurality of applications, the code for the plurality of applications may exhibit unified and/or consistent layout structures and/or interface designs, and thus the plurality of applications may have visual and/or functional consistency, which may reflect their association with the first entity (making the first entity recognizable to users, for example) and/or may help users develop familiarity with the interface across various applications, thereby enhancing usability and/or providing a seamless and/or predictable user experience and/or providing for reduced code and/or functionality duplication across applications of the first design environment (e.g., interface elements may be re-used when similar UI design representations are used for code generation).

The trained code generation model 118 may comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

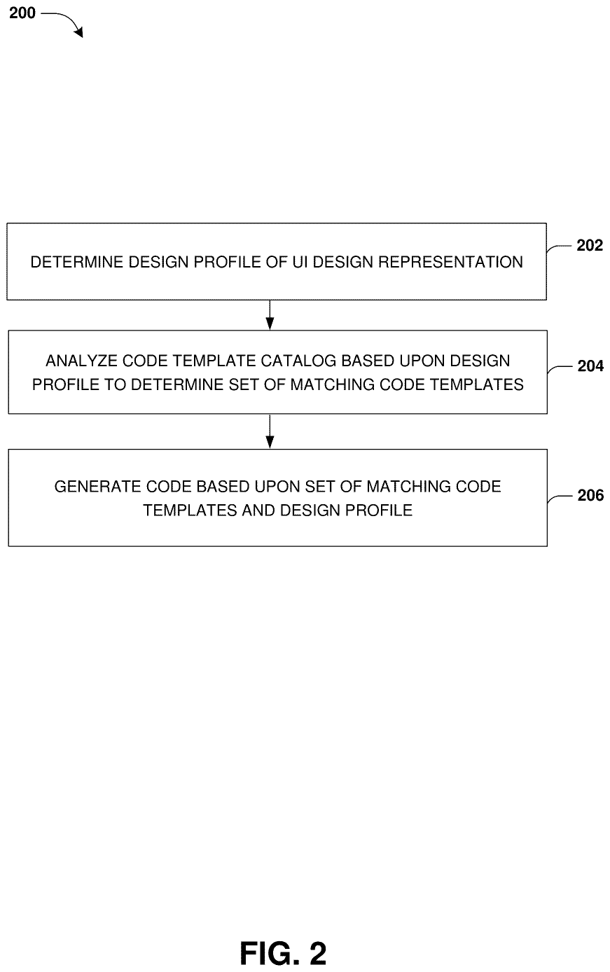

An embodiment of converting a UI design representation (e.g., the UI design representation 102) to code (e.g., the code 110) is illustrated by an exemplary method 200 of FIG. 2. At 202, a design profile (e.g., the design profile 106) of the UI design representation may be determined. The design profile may be indicative of one or more first attributes (e.g., the one or more attributes 152) of a first interface element (e.g., the frame 167) of the UI design representation and/or one or more second attributes (e.g., the one or more attributes 158) of a second interface element (e.g., the button 165) of the UI design representation. At 204, a code template catalog (e.g., the code template catalog 138) may be analyzed based upon the design profile to determine a set of matching code templates (e.g., the set of matching code templates 148) determined to match interface elements of the UI design representation. The set of matching code templates comprises a first code template (e.g., the second code template 132) determined to match the first interface element and a second code template (e.g., the third code template 136) determined to match the second interface element. At 206, the code may be generated based upon the set of matching code templates and the design profile. The code comprises a first set of code (e.g., the first set of code 156) generated based upon the first code template and the one or more first attributes and a second set of code (e.g., the second set of code 160) generated based upon the second code template and the one or more second attributes.

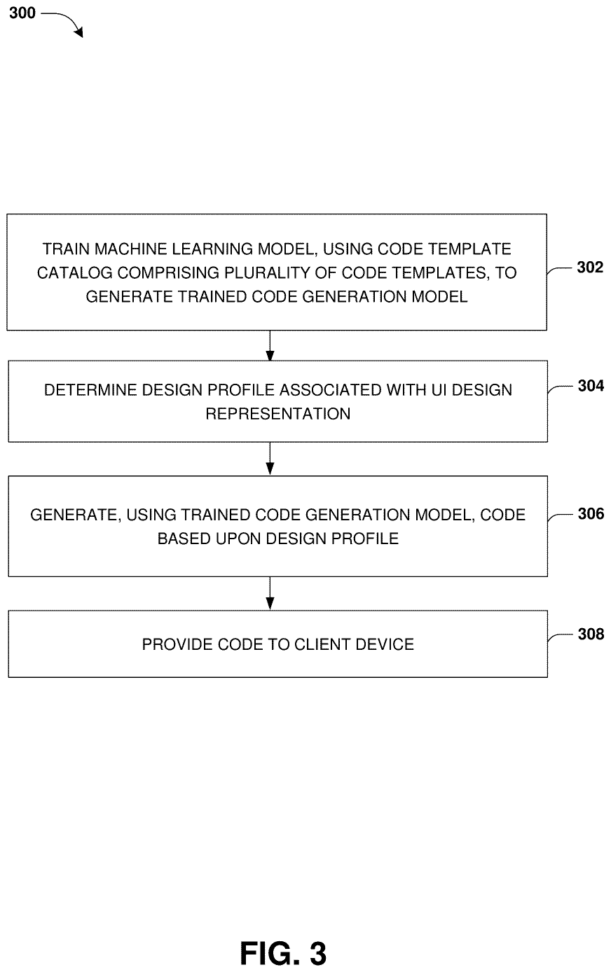

An embodiment is illustrated by an exemplary method 300 of FIG. 3. At 302, a machine learning model may be trained using a code template catalog comprising a plurality of code templates to generate a trained code generation model (e.g., the trained code generation model 118). At 304, a design profile associated with a UI design representation (e.g., the UI design representation 102) may be determined. The design profile may be indicative of one or more first attributes (e.g., the one or more attributes 152) of a first interface element (e.g., the frame 167) of the UI design representation and/or one or more second attributes (e.g., the one or more attributes 158) of a second interface element (e.g., the button 165) of the UI design representation. At 306, code (e.g., the code 110) may be generated using the trained code generation model based upon the design profile. At 308, the code may be provided to a client device.

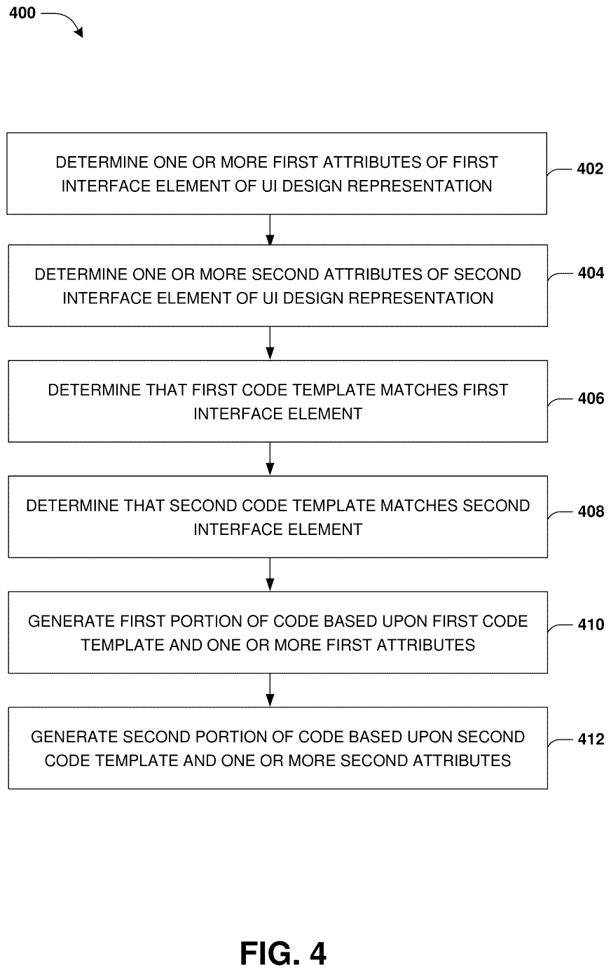

An embodiment of converting a UI design representation (e.g., the UI design representation 102) to code (e.g., the code 110) is illustrated by an exemplary method 400 of FIG. 4. At 402, one or more first attributes (e.g., the one or more attributes 152) of a first interface element of the UI design representation may be determined. At 404, one or more second attributes (e.g., the one or more attributes 158) of a second interface element of the UI design representation may be determined. At 406, a first code template (e.g., the second code template 132) may be determined to match the first interface element. At 408, a second code template (e.g., the third code template 136) may be determined to match the second interface element. At 410, a first portion (e.g., the first set of code 156) of the code may be generated based upon the first code template and the one or more first attributes. At 412, a second portion (e.g., the second set of code 160) of the code may be generated based upon the second code template and the one or more second attributes.

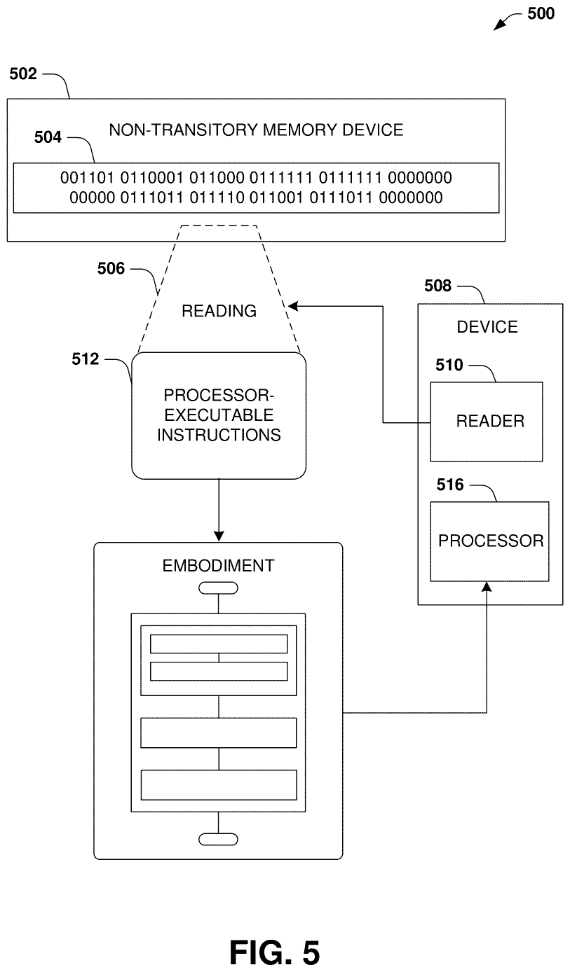

FIG. 5 is an illustration of a scenario 500 involving an example non-transitory machine-readable medium 502. The non-transitory machine-readable medium 502 may comprise processor-executable instructions 512 that when executed by a processor 516 cause performance (e.g., by the processor 516) of at least some of the provisions herein. The non-transitory machine-readable medium 502 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 502 stores computer-readable data 504 that, when subjected to reading 506 by a reader 510 of a device 508 (e.g., a read head of a hard disk drive, or a read operation invoked on a solid-state storage device), express the processor-executable instructions 512. In some embodiments, the processor-executable instructions 512, when executed cause performance of operations, such as at least some of the example method 200 of FIG. 2, at least some of the example method 300 of FIG. 3, and/or at least some of the example method 400 of FIG. 4, for example. In some embodiments, the processor-executable instructions 512 are configured to cause implementation of a system, such as at least some of the example system 101 of FIGS. 1A-1O, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for converting a user interface (UI) design representation to code comprising:
determining a design profile, of the UI design representation, indicative of:
one or more first attributes of a first interface element of the UI design representation; and
one or more second attributes of a second interface element of the UI design representation;
analyzing a code template catalog based upon the design profile to determine a set of matching code templates determined to match interface elements of the UI design representation, wherein the set of matching code templates comprises:
a first code template determined to match the first interface element; and
a second code template determined to match the second interface element; and
generating the code based upon the set of matching code templates and the design profile, wherein the code comprises:
a first set of code generated based upon the first code template and the one or more first attributes; and
a second set of code generated based upon the second code template and the one or more second attributes.

2. The method of claim 1, wherein:
the one or more first attributes comprise at least one of a first position of the first interface element or a first depth-level of the first interface element;
the one or more second attributes comprise at least one of a second position of the first interface element or a second depth-level of the second interface element; and
generating the code comprises:
determining a position in the code for the first set of code based upon at least one of the first position or the first depth-level; and
determining a position in the code for the second set of code based upon at least one of the second position or the second depth-level.

3. The method of claim 1, wherein:
the design profile is indicative of a relationship between the first interface element and the second interface element; and
generating the code comprises arranging the first set of code relative to the second set of code based upon the relationship.

4. The method of claim 1, wherein:
the one or more first attributes comprise a first interface element tag;
the one or more second attributes comprise a second interface element tag; and
determining the set of matching code templates comprises:
determining that the first code template matches the first interface element based upon the first interface element tag matching an interface element tag associated with the first code template; and
determining that the second code template matches the second interface element based upon the second interface element tag matching an interface element tag associated with the second code template.

5. The method of claim 1, comprising:
generating a visual design representation based upon the code; and
displaying the visual design representation via a graphical user interface, wherein:
a first portion of the visual design representation corresponding to the first interface element is rendered according to the first set of code; and
a second portion of the visual design representation corresponding to the second interface element is rendered according to the second set of code.

6. The method of claim 1, comprising:
providing the code to a client device.

7. The method of claim 1, comprising:
generating a visual design representation based upon the code; and
displaying, on a client device, an interface comprising:
the visual design representation; and
a representation of the code.

8. The method of claim 1, comprising:
displaying a design portion selection interface on a client device;
receiving, via the design portion selection interface, a request indicative of a portion of the UI design representation; and
in response to the request, at least one of:
extracting a subset of code that corresponds to the portion of the UI design representation from the code; or
providing a file comprising the subset of code to the client device.

9. The method of claim 1, wherein:
the one or more first attributes comprise at least one of a first interface element tag, a first position of the first interface element or a first depth-level of the first interface element; and
the one or more second attributes comprise at least one of a second interface element tag, a second position of the second interface element or a second depth-level of the second interface element.

10. The method of claim 1, wherein:
the design profile is indicative of a relationship between the first interface element and the second interface element.

11. A computer comprising:
a processor coupled to memory, the processor configured to execute instructions from the memory to perform operations comprising:
training a machine learning model, using a code template catalog comprising a plurality of code templates, to generate a trained code generation model;
determining a design profile associated with a user interface (UI) design representation, wherein the design profile is indicative of:
one or more first attributes of a first interface element of the UI design representation; and
one or more second attributes of a second interface element of the UI design representation;
generating, using the trained code generation model, code based upon the design profile; and
providing the code to a client device.

12. The computer of claim 11, wherein:
the one or more first attributes comprise at least one of a first position of the first interface element or a first depth-level of the first interface element;
the one or more second attributes comprise at least one of a second position of the first interface element or a second depth-level of the second interface element; and
generating the code comprises:
generating a first set of code associated with the first interface element based upon the one or more first attributes;
generating a second set of code associated with the second interface element based upon the one or more second attributes;
determining a position in the code for the first set of code based upon at least one of the first position or the first depth-level; and
determining a position in the code for the second set of code based upon at least one of the second position or the second depth-level.

13. The computer of claim 11, wherein:
the design profile is indicative of a relationship between the first interface element and the second interface element; and
generating the code comprises:
generating a first set of code associated with the first interface element based upon the one or more first attributes;
generating a second set of code associated with the second interface element based upon the one or more second attributes; and
arranging the first set of code relative to the second set of code based upon the relationship.

14. The computer of claim 11, the operations comprising:
generating a visual design representation based upon the code; and
displaying the visual design representation via a graphical user interface.

15. The computer of claim 14, the operations comprising:
displaying a representation of the code via the graphical user interface.

16. The computer of claim 11, the operations comprising:
displaying a design portion selection interface on the client device;
receiving, via the design portion selection interface, a request indicative of a portion of the UI design representation; and
in response to the request, at least one of:
extracting a subset of code that corresponds to the portion of the UI design representation from the code; or
providing a file comprising the subset of code to the client device.

17. A non-transitory computer-readable medium storing instructions that when executed perform operations for converting a UI design representation to code, the operations comprising:
determining one or more first attributes of a first interface element of the UI design representation;
determining one or more second attributes of a second interface element of the UI design representation;
determining that a first code template matches the first interface element;
determining that a second code template matches the second interface element;
generating a first portion of the code based upon the first code template and the one or more first attributes; and
generating a second portion of the code based upon the second code template and the one or more second attributes.

18. The non-transitory computer-readable medium of claim 17, wherein:
the one or more first attributes comprise a first interface element tag;
the one or more second attributes comprise a second interface element tag;
determining that the first code template matches the first interface element is based upon a determination that the first interface element tag matches an interface element tag associated with the first code template; and
determining that the second code template matches the second interface element is based upon a determination that the second interface element tag matches an interface element tag associated with the second code template.

19. The non-transitory computer-readable medium of claim 17, comprising:
generating a visual design representation based upon the code; and
displaying the visual design representation via a graphical user interface, wherein:
a first portion of the visual design representation corresponding to the first interface element is rendered according to the first portion of the code; and
a second portion of the visual design representation corresponding to the second interface element is rendered according to the second portion of the code.

20. The non-transitory computer-readable medium of claim 17, the operations comprising:
providing the code to a client device.
